(19) United States
(12) Patent Application Publication
(10) Pub. No.: US 2010/0210979 A1
(43) Pub. Date: Aug. 19, 2010

(54) CHAIR TYPE MASSAGE MACHINE

(75) Inventors: Shinji Tsutsui, Hirakata (JP); Koji Terada, Hikone (JP); Keisuke Shimizu, Suita (JP)

Correspondence Address: SHERIDAN ROSS PC, 1560 BROADWAY, SUITE 1200, DENVER, CO, 80202, US

(73) Assignee: PANASONIC ELECTRIC WORKS CO., LTD., Osaka (JP)

(21) Appl. No.: 12/679,561

(22) PCT Filed: Sep. 17, 2008
(86) PCT No.: PCT/JP2008/066744

§ 371 Date: Mar. 23, 2010

(30) Foreign Application Priority Data
Sep. 28, 2007 (JP) 2007-255853

(51) Int. Cl. A61H 1/00; A44B 18/00

(52) U.S. Cl. 601/24; 24/442

(57) ABSTRACT

A chair type massage machine that enables a massager to effectively perform massages, ensures safety, reduces costs, and allows for easy attachment and removal of a cushion to and from a backrest. The massage machine includes a massage unit (5) that may be raised and lowered in a backrest (2). The massage unit (5) includes a massager (7) projecting toward the front from the backrest (2). A cushion (4) is formed to be generally U-shaped and arranged on a front surface of the backrest (2). The cushion (4) includes an opening (8) in which is arranged the massager (7), which is lowered and raised with the massage unit (5). The massager (7) is movable in the opening (8) of the cushion (4). A fastening means fastens the cushion (4) to the front surface of the backrest (2). The fastening includes hook-and-loop fasteners (10, 11) that are separated by application of downward external force of a certain amount or more to a lower rim of the opening (8) in the cushion (4).

### TECHNICAL FIELD

The present invention relates to a chair type massage machine including a cushion arranged on a front surface of a backrest.

### BACKGROUND ART

Patent document 1 describes an example of a chair type massage machine known in the prior art that includes a massage unit, which may be raised and lowered in a backrest, and a massager, which is arranged on the massage unit and projects toward the front from the backrest. The massage machine of patent document 1 includes a cushion, which is arranged on a front surface of the backrest and has a generally rectangular shape. The massage machine performs massages with the massager through the cushion. Thus, the massager may not effectively perform massages.

FIG. 4 shows a further prior art example in which hook-and-loop fasteners are used to fasten cushions 4a to 4c respectively to one side portion, another side portion, and a lower central portion on a front surface of a backrest 2. The arrangement of the three cushions 4a to 4c is generally U-shaped. The three cushions 4a to 4c, which are generally U-shaped as a whole, form an opening 8. Massagers 7 are movably arranged in the opening 8.

The cushion 4b at the lower central portion as viewed in FIG. 4 is discrete from the cushions 4a and 4c located on opposite sides of the cushion 4b for reasons that will now be discussed. If the three cushions 4a to 4c arranged on the front surface of the backrest 2 are formed integrally as a generally U-shaped cushion, when the massagers 7, which project toward the front from the backrest 2 move downward in the opening 8, a small child's neck or the like may become entrapped between the massagers 7 and the lower rim of the opening 8 (lower portion of cushion). Accordingly, in FIG. 4, the cushion 4b is discrete so that only the cushion 4b falls off from the backrest 2 when a small child's neck or the like becomes entrapped between the massagers 7 and the cushion 4b. This solves the problem discussed above.

However, the three cushions 4a to 4c for the chair type massage machine shown in FIG. 4 must be separately manufactured. This increases manufacturing costs. Further, the attachment and removal of the cushions 4a to 4c to and from the backrest is burdensome.
Patent Document 1: Japanese Laid-Open Patent Publication No. 2000-350758

### DISCLOSURE OF THE INVENTION

The present invention provides a chair type massage machine that enables a massager to effectively perform massages, ensures safety, reduces costs, and allows for easy attachment and removal of a cushion to and from a backrest.

One aspect of the present invention is a chair type massage machine including a backrest. The chair type massage machine includes a massage unit that may be raised and lowered in the backrest. A massager is arranged on the massage unit and projects toward the front from the backrest. A cushion is formed to be generally U-shaped and arranged on a front surface of the backrest. The cushion includes an opening in which the massager is movably arranged. A fastening means fastens the cushion to the front surface of the backrest. The fastening means includes at least one pair of first hook-and-loop fasteners that are separated by application of downward external force of a certain amount or more to a lower rim of the opening.

### BRIEF DESCRIPTION OF THE DRAWINGS

FIG. 1 is a perspective view showing an example of a chair type massage machine according to one embodiment of the present invention;

FIG. 2 is an explanatory diagram showing the chair type massage machine of FIG. 1 in a state of use;

FIG. 3 is a perspective view showing another example of a chair type massage machine; and

FIG. 4 is a perspective view showing a prior art chair type massage machine.

### BEST MODE FOR CARRYING OUT THE INVENTION

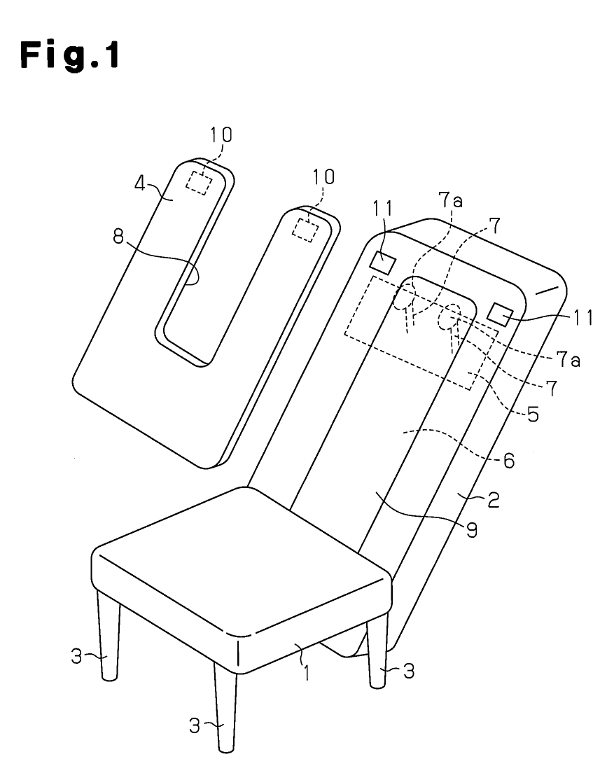

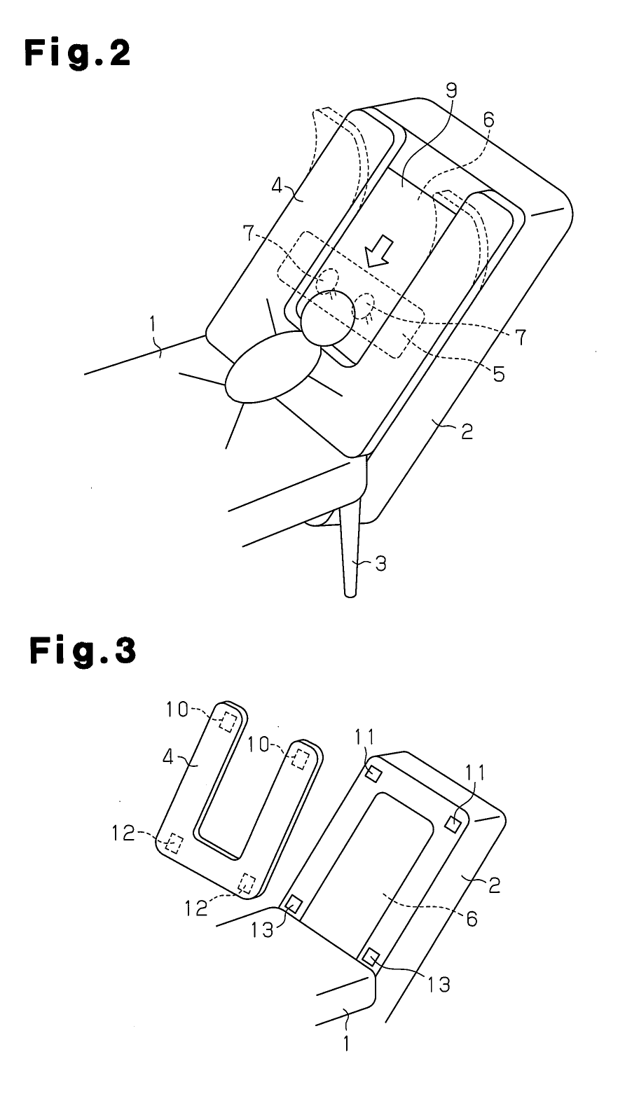

A chair type massage machine according to one embodiment of the present invention will now be discussed with reference to the drawings. As shown in FIGS. 1 and 2, one example of a chair type massage machine according to the present embodiment mainly includes a seat 1, which is installed on a floor and supported by legs 3 arranged at its four corners, and a backrest 2, which extends upward from a rear end of the seat 1. A cushion 4, which improves the cushioning characteristics, is removably attached to a front surface of the backrest 2 that serves as backrest surface. The backrest 2 is formed by a frame made of synthetic resin.

The backrest 2, which is inclined toward the rear in FIG. 1, includes a massage unit 5, which is raised and lowered in the backrest 2 by a driving means (not shown). Massagers 7 project from opposite sides of the massage unit 5 toward the front from a pocket 6 formed in the backrest 2. The pocket 6 has a rectangular shape elongated in the vertical direction and is formed in the front surface of the backrest 2. A massaging element 7a, which is formed by a massaging roller, is arranged on a distal end of each massager 7. In a state in which the massage unit 5 is being lowered and raised or in a state in which the massage unit 5 is arranged at a predetermined height, a person to receive a massage sits on the seat 1 and places his or her back or waist against the massaging elements 7a. Then, the massagers 7 are driven to perform a massage. The massagers 7 are covered by a cover 9, such as a cloth that closes the pocket 6, and not exposed to the exterior.

The cushion 4, which is arranged along the front surface of the backrest 2, is plate-shaped and somewhat thick. The cushion 4, which is generally U-shaped and has an open upper end, is formed monolithically. An opening 8, which has a rectangular shape elongated in the vertical direction, is formed in the cushion 4. The opening 8 extends downward from the top end of the cushion 4 through a central portion in the widthwise direction. The opening 8 is overlapped with an upper portion of the pocket 6 in the backrest 2, and the two side portions of the cushion 4 cover the two side portions in the front surface of the backrest 2. Further, a lower central connection portion, which covers the two side portions of the cushion 4, covers a lower portion of the pocket 6 in the backrest 2. In other words, except for the upper portion, the cushion 4 covers the pocket 6 in the front surface of the backrest 2.

A fastening means for fastening the cushion 4 to the front surface of the backrest 2 includes two hook-and-loop fasteners 10 and 10, which are arranged on a rear surface of the cushion 4, and two hook-and-loop fasteners 11 and 11, which are arranged on the front surface of the backrest 2 in correspondence with the hook-and-loop fasteners 10 and 10. One of the hook-and-loop fasteners 10 and one of the hook-and-loop fasteners 11 form a pair of hook-and-loop fasteners. In the illustrated example, the male hook-and-loop fasteners 10 and 10, of which fastening surfaces are hook surfaces, are respectively arranged on the top part of two outer portions in the rear surface of the cushion 4 located on opposite sides of the opening 8. The female hook-and-loop fasteners 11 and 11, of which fastening surfaces are loop surfaces, are respectively arranged on the backrest 2 at locations corresponding to the hook-and-loop fasteners 10 and 10, namely, the top part of the two side portions of the backrest 2. Further, the hook-and-loop fasteners 10 and 10 arranged on the cushion 4 are removably attached to the corresponding hook-and-loop fasteners 11 and 11 arranged on the backrest 2. The present embodiment uses two pairs of the hook-and-loop fasteners 10, 10 and 11, 11. However, just one pair of the hook-and-loop fasteners 10 and 11 may be used. For example, a rectangular hook-and-loop fastener 10 connecting the top end of the two side portions of the cushion 4 may be arranged on the cushion 4, and a corresponding rectangular hook-and-loop fastener 11 may be arranged on the backrest 2.

The massagers 7, which are moved upward and downward together with the massage unit 5, are arranged in the pocket 6 of the backrest 2 and in the opening 8 of the cushion 4, which is attached to the front surface of the backrest 2. This allows for the massagers 7 to be raised and lowered in the pocket 6 of the backrest 2 and the opening 8 of the cushion 4 without contacting the backrest 2 and the cushion 4 in the raising and lowering range of the massage unit 5.

The fastening force of the hook-and-loop fasteners 10 and 11, which serve as a means for fastening the cushion 4 to the backrest 2, is set so that the hook-and-loop fasteners 10 and 11 are separated when a downward external force of a certain amount or more is applied to the lower rim of the opening 8 in the cushion 4. This is achieved by changing the area of the fastening surface or by changing the type of the fastening surface, for example, to a mohair type or a loop type. The fastening force described here is set so that each pair of the hook-and-loop fasteners 10 and 11 do not normally separate when a person to receive a massage just rests on the cushion 4 and the backrest 2 but separate when a child's neck or the like becomes entrapped between the massagers 7 and the lower rim of the opening 8 in the cushion 4 as the massage unit 5 descends. As described above, the pairs of hook-and-loop fasteners 10 and 11 are formed by male and female hook-and-loop fasteners 10 and 11. However, the hook-and-loop fasteners 10 and 11 may be formed by a pair of hook-and-loop fasteners that includes both hooks and loops on their fastening surfaces and thus may not be categorized into male and female.

The chair type massage machine according to the present embodiment has the advantages described below.

(1) The generally U-shaped cushion 4 is arranged on the front surface of the backrest 2, and the massagers 7, which are raised and lowered together with the massage unit 5, are arranged in the opening 8 of the cushion 4 so that the massagers 7 are movable in the opening 8 of the cushion 4. Accordingly, the massages 7 may be directly placed against the back or waist of a person who will be receiving a massage. This allows for the massagers 7 to effectively perform a massage.

(2) The fastening means for fastening the cushion 4 to the front surface of the backrest 2 is formed by the hook-and-loop fasteners 10 and 11, which are separated when a downward external force of a certain amount or more is applied to the lower rim of the opening 8 in the cushion 4. Thus, if, by any possibility, a child's neck or the like becomes entrapped between the massagers 7 and the lower rim of the opening 8 in the cushion 4 as the massage unit 5 descends, the hook-and-loop fasteners 10 and 10 arranged on the cushion 4 separate from the corresponding hook-and-loop fasteners 11 and 11 arranged on the backrest 2. Accordingly, the cushion 4 falls down from the backrest 2. This prevents entrapment and ensures safety.

(3) The cushion 4 is generally U-shaped and formed monolithically. Further, the cushion 4 is easily attached to and removed from the backrest 2.

The embodiment discussed above may be modified as described below.

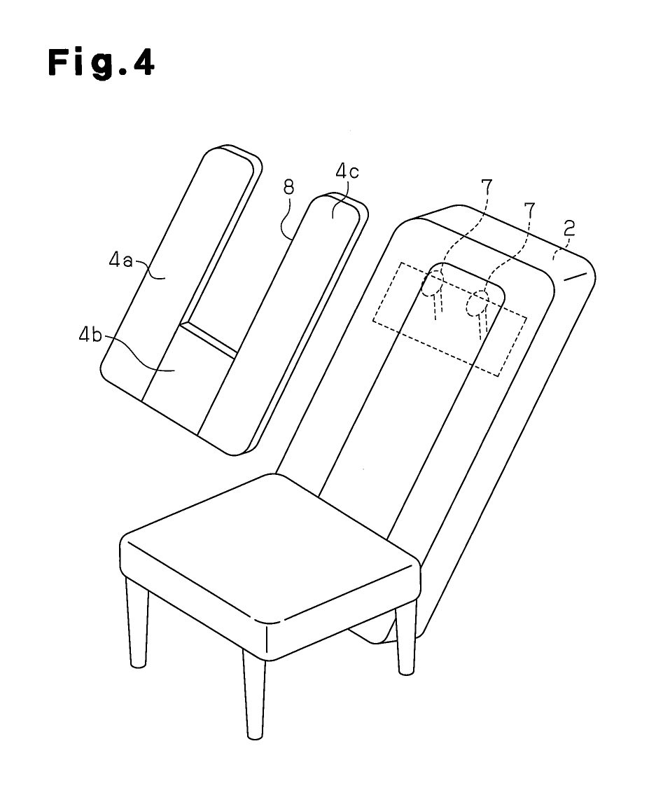

As shown in FIG. 3, in addition to the two pairs of hook-and-loop fasteners 10, 10 and 11, 11, which are similar to those of FIG. 1, two hook-and-loop fasteners 12 may be arranged on the rear surface of the cushion 4 at locations lower than the lower rim of the opening 8. Further, two hook-and-loop fasteners 13 and 13, which are paired with the hook-and-loop fasteners 12 and 12, may be arranged on the front surface of the backrest 2 at locations corresponding to the hook-and-loop fasteners 12 and 12. More specifically, in the example of FIG. 3, the male hook-and-loop fasteners 12 and 12, of which fastening surfaces are hook surfaces, are arranged on the bottom part of two side portions in the cushion 4. The female hook-and-loop fasteners 13 and 13, of which fastening surfaces are loop surfaces, are arranged on the backrest 2 at locations corresponding to the hook-and-loop fasteners 12 and 12. Further, the fastening surface of each hook-and-loop fastener 11 arranged in the top portion of the backrest 2 is of a loop type, which easily separates. In contrast, the fastening surface of each hook-and-loop 13 arranged in the bottom portion of the backrest 2 is of a mohair type, which is difficult to separate. As a result, the fastening force of the hook-and-loop fasteners 12 and the hook-and-loop fasteners 13 is greater than the fastening force of the hook-and-loop fasteners 10 and the hook-and-loop fasteners 11. The difference in the fastening force of the hook-and-loop fasteners 10 and 11 and the hook-and-loop fasteners 12 and 13 may be obtained by varying the areas of the fastening surfaces. Although there are two pairs of the hook-and-loop fasteners 12, 12 and 13, 13, there may be just one pair of the hook-and-loop fasteners 12 and 13.

In the massage machine of FIG. 3, fastening of the cushion 4 to the backrest 2 is ensured. Further, the cushion 4 is preventing from becoming lost. Moreover, the hook-and-loop fasteners 12 and 12 are arranged at locations lower than the lower rim of the opening 8 in the cushion 4. Thus, if a child's neck or the like becomes entrapped between the massagers 7 and the lower rim of the opening 8 in the cushion 4 as the massage unit 5 descends, the hook-and-loop fasteners 10 and 10 separate with no difficulty from the corresponding hook-and-loop fasteners 11 and 11 arranged on the backrest 1. This improves safety.

1. A chair type massage machine including a backrest, the chair type massage machine comprising:
a massage unit that may be raised and lowered in the backrest;
a massager arranged on the massage unit and projecting toward the front from the backrest;
a cushion formed to be generally U-shaped and arranged on a front surface of the backrest, the cushion including an opening in which the massager is movably arranged; and
a fastening means for fastening the cushion to the front surface of the backrest;
wherein the fastening means includes at least one pair of first hook-and-loop fasteners that are separated by application of downward external force of a certain amount or more to a lower rim of the opening.

2. The chair type massage machine according to claim 1, wherein the first hook-and-loop fasteners are arranged on the backrest and the cushion at locations above the lower rim of the opening.

3. The chair type massage machine according to claim 2, wherein the fastening means further includes:
at least one pair of second hook-and-loop fasteners arranged on the backrest and the cushion at locations below the lower rim of the opening and separated by application of downward external force of a certain amount or more to the lower rim of the opening; and
the first hook-and-loop fasteners have a fastening force that is weaker than the second hook-and-loop fasteners.
